(19) United States
(12) Patent Application Publication
(10) Pub. No.: US 2025/0086666 A1
(43) Pub. Date: Mar. 13, 2025

(54) METHOD, PROGRAM AND APPARATUS FOR CONDUCTING SURVEYS BASED ON GENERATIVE ARTIFICIAL INTELLIGENCE

(71) Applicant: Impactive AI CO., LTD., Gyeongsangbuk-do (KR)

(72) Inventor: Doohee CHUNG, Gyeongsangbuk-do (KR)

(21) Appl. No.: 18/768,385

(22) Filed: Jul. 10, 2024

(30) Foreign Application Priority Data
Sep. 12, 2023 (KR) 10-2023-0120801
Oct. 25, 2023 (KR) 10-2023-0144076

(51) Int. Cl. G06Q 30/0203; G06Q 30/0204

(52) U.S. Cl. CPC G06Q 30/0203; G06Q 30/0204

(57) ABSTRACT

According to an embodiment of the present disclosure, there are disclosed a method, program and apparatus for conducting surveys based on generative artificial intelligence. The method is performed by a computing apparatus including at least one processor. The method includes: obtaining survey information and persona information about a survey respondent; and generating response data based on the survey information and the persona information about the survey respondent by using a pre-trained first language model.

### CROSS-REFERENCE TO RELATED APPLICATION

This application claims the benefit of Korean Patent Application No. 10-2023-0120801 filed in the Korean Intellectual Property Office on Sep. 12, 2023 and Korean Patent Application No. 10-2023-0144076 filed in the Korean Intellectual Property Office on Oct. 25, 2023. These applications are hereby incorporated by reference herein in their entireties.

### BACKGROUND

### 1. Technical Field

The present disclosure relates generally to a method of conducting surveys based on generative artificial intelligence, and more particularly to a method and apparatus that may provide response data based on survey information and persona information about survey respondents by using pre-trained artificial intelligence-based models.

### 2. Description of the Related Art

Generally, survey methods include a traditional survey method in which a surveyor randomly selects target respondents, calls and talks to them or meets them and asks them questions about a survey in person, and then organizes survey results based on the responses of the target respondents, and an online survey method using a survey system and multiple user computers connected online over a network such as the Internet.

In the online survey method, the survey system generates a questionnaire, including survey items, in the form of an e-mail or the like in accordance with a request from a survey requester and transmits it to panels or survey respondents. The survey response results provided by the survey respondents are received in the survey system, and the survey system analyzes the survey response results, generates a final survey report, and provides it to the survey requester.

The conventional survey methods have problems in that considerable amounts of time and money are required to gather a large number of survey respondents and the processes of distributing questionnaires to respondents and collecting responses are not only time consuming but also cumbersome.

The traditional survey method that obtains responses through phone calls or in-person interviews requires more effort and cost than the online survey method. As a result, survey requesters or surveyors with small budgets or time constraints have many difficulties in obtaining desired survey response results.

Online surveys have the advantage of being able to conduct surveys rapidly and inexpensively compared to conventional offline or phone surveys. Online surveys are widely used to determine consumer preferences for various products or services or to obtain other types of marketing data.

However, the online surveys have problems in that there are no clear measures to ensure response reliability other than securing personal information and continuously updating it and in that it is difficult to generate or analyze responses while considering the various personas of survey respondents.

In most online surveys, survey response results in which diversity such as gender, age, occupation, and cultural background has not been sufficiently taken into consideration may be received from individual survey respondents and, when the number of survey respondents is not sufficient, survey response results may be distorted due to the subjectivity of individual survey respondents. As a result, there is a problem in that it is not possible to obtain high-quality data for the reliability and meaningful analysis of the survey response results.

### Prior Art Literature

Patent Document: Korean Patent No. 10-2288995 (published on Aug. 5, 2021)

### SUMMARY

The present disclosure has been conceived in response to the above-described background technology, and an object of the present invention is to provide a method and apparatus based on generative artificial intelligence that may generate response data like humans based on survey information and persona information about survey respondents in an agent based on artificial intelligence-based models and may derive meaningful information by analyzing the patterns, reliability, and relevance of the response data through various analysis techniques.

However, the objects to be accomplished in the present disclosure are not limited to the object mentioned above, and other objects not mentioned may be clearly understood based on the following description.

According to an embodiment of the present disclosure for achieving the above-described object, there is disclosed a method of conducting surveys based on generative artificial intelligence that is performed by a computing apparatus including at least one processor. The method includes: obtaining survey information and persona information about a survey respondent; and generating response data based on the survey information and the persona information about the survey respondent by using a pre-trained first language model.

Alternatively, obtaining the survey information and the persona information about the survey respondents may include: extracting detailed characteristic: information about the survey respondent based on basic information about the survey respondent and question information related to the basic information by using a pre-trained second language model; selecting main characteristic information to be used to obtain the persona information from detailed characteristic information, generated by the second language model, based on user input; and generating the persona information based on the main characteristic information and additional question information related to the main characteristic information by using the second language model.

Alternatively, when a plurality of pieces of main characteristic information are selected as the main characteristic information, the persona information may be generated by combining the plurality of pieces of main characteristic information.

Alternatively, the second language model may be dynamically re-trained based on user feedback on the generated persona information or the performance metrics of the second language model.

Alternatively, the persona information may be based on a classification system stratified according to the characteristics of the survey respondent.

Alternatively, the classification system may include: a first classification system for basic characteristics including demographic information, occupational and professional information, and education level information; a second classification system for lifestyle including hobby and interest information, consumption habit information, and health and physical information; a third classification system for view-of-value and psychological characteristics including a view of value, personality, decision-making style, and communication style; a fourth classification system for technology and media usage habits including technology consumption preferences and media consumption patterns; and a fifth classification system for social networks and relationships including social relationships and social networking habits.

Alternatively, the response data generated through the first language model may be used to adjust the language distribution of the first language model or re-train the first language model based on user feedback.

Alternatively, when the persona information includes a plurality of pieces of persona information, the response data generated through the first language model may include response information and statistical information generated for each of the plurality of pieces of persona information.

Alternatively, the method may further include analyzing at least one of the pattern, reliability, and relevance of the response data by using a decision-making technique.

Meanwhile, a computing apparatus for implementing a method of conducting surveys based on generative artificial intelligence according to an embodiment of the present disclosure includes a processor including at least one core, and memory including program codes executable on the processor, and the processor, according to execution of the program codes, survey obtains information and persona information about a survey respondent and generates response data based on the survey information and the persona information about the survey respondent by using a pre-trained first language model.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a computing apparatus according to an embodiment of the present disclosure;

FIG. 2 is a flowchart illustrating a method of conducting surveys based on generative artificial intelligence according to an embodiment of the present disclosure; and

FIG. 3 is a flowchart showing in detail the step of acquiring persona information according to an embodiment of the present invention.

### DETAILED DESCRIPTION

Embodiments of the present disclosure will be described in detail below with reference to the accompanying drawings so that those having ordinary skill in the art of the present disclosure (hereinafter referred to as those skilled in the art) can easily implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein can be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

The term “connected” used herein should be interpreted to include not only the case where components are “directly connected” to each other, but also the case where components are “electrically connected” to each other and the case where components are “connected” to each other with a third component interposed therebetween.

The term “acquisition” used herein can be understood to refer to not only receiving data through a wireless communication network with an external device or system, but also generating or receiving data in an on-device form.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component components of a computing apparatus, an application program performing a specific function of software, a procedure implemented through the execution of software, a set of instructions for the execution of a program, or the like. Additionally, in the broad sense, the term “module” or “unit” may refer to a computing apparatus itself constituting part of a system, an application running on the computing apparatus, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a deep learning “model” may refer to an overall system implemented as a neural network that is provided with problem-solving capabilities through training. In this case, the neural network may be provided with problem-solving capabilities by optimizing parameters connecting nodes or neurons through training. The deep learning “model” may include a single neural network, or a neural network set in which multiple neural networks are combined together.

The foregoing descriptions of the terms are intended to help to understand the present disclosure. Accordingly, it should be noted that unless the above-described terms are explicitly described as limiting the content of the present disclosure, the terms in the content of the present disclosure are not used in the sense of limiting the technical spirit of the present disclosure.

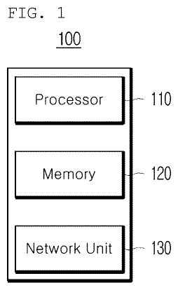

FIG. 1 is a block diagram of a computing apparatus according to an embodiment of the present disclosure.

A computing apparatus 100 according to an embodiment of the present disclosure may be a hardware device or part of a hardware device that performs the comprehensive processing and calculation of data, or may be a software-based computing environment that is connected to a communication network. For example, the computing apparatus 100 may be a server that performs an intensive data processing function and also shares resources through communication with clients. Furthermore, the computing apparatus 100 may be a cloud system that enables pluralities of servers and clients to comprehensively process data. Since the above descriptions are only examples related to the type of computing apparatus 100, the type of computing apparatus 100 may be configured in various manners within a range understandable to those skilled in the art based on the content of the present disclosure.

Referring to FIG. 1, the computing apparatus 100 according to an embodiment of the present disclosure may include a processor 110, memory 120, and a network unit 130. However, FIG. 1 shows only an example, and the computing apparatus 100 may include other components for implementing a computing environment. only Furthermore, some of the components disclosed above may be included in the computing apparatus 100.

The processor 110 according to an embodiment of the present disclosure may be understood as a configuration unit including hardware and/or software for performing computing operation. For example, the processor 110 may process commands generated as a result of user interaction through a user interface. Furthermore, the processor 110 may read a computer program and perform data processing for machine learning. The processor 110 may process computational processes such as the processing of input data for machine learning, the extraction of features for machine learning, and the calculation of errors based on backpropagation. The processor 110 for performing such data processing and operations may include a central processing unit (CPU), a general purpose graphics processing unit (GPGPU), a tensor processing unit (TPU), an application specific integrated circuit (ASIC), or a field programmable gate array (FPGA). Since the types of processor 110 described above are only examples, the type of processor 110 may be configured in various manners within a range understandable to those skilled in the art based on the content of the present disclosure.

The processor 110 generate may an artificial intelligence-based agent that responds to a survey by using a pre-trained first language model, and may generate response data based on survey information and persona information about survey respondents by using the agent.

In this case, the artificial intelligence-based agent is a dedicated program 1 Intelligence (e.g., (AI)-based services voice recognition service, secretary service, translation service, search service, survey service, etc.), and may be executed by an existing general-purpose processor or a separate AI-specific processor (e.g., a graphics processing unit (GPU), or the like). In particular, the agent may control various modules, which will be described later.

The processor 110 may generate response data based on survey information and persona information using the pre-trained first language model. Furthermore, the processor 110 may extract characteristics required for generating persona information based on the training dataset and train the second language model that generates persona information based on the extracted characteristics. Furthermore, the processor 110 may generate persona information using the trained second language model.

For example, the first and second language models may be generative AI models, or more specifically, large language models (LLMs). Accordingly, the processor 110 may generate an agent that responds to a survey based on persona information by using a generative artificial intelligence model based on an LLM.

The processor 110 may extract characteristics to be used to obtain persona information using the second language model generated through the above-described training process, and may estimate persona information by dynamically performing persona profiling based on the extracted characteristics. The processor 110 may generate response data representing the results estimated by reflecting persona information for survey questions and knowledge information at the time when the survey is conducted therein by inputting survey information and the persona information to the first language model trained through the above-described process.

In addition to the examples described above, the types of training datasets according to language distribution and the outputs of the first and second language models may be configured in various manners within a range understandable to those skilled in the art based on the content of this disclosure.

The memory 120 according to an embodiment of the present disclosure may be understood as a configuration unit including hardware and/or software for storing and managing data that is processed in the computing apparatus 100. That is, the memory 120 may store any type of data generated or determined by the processor 110 and any type of data received by the network unit 130. For example, the memory 120 may include at least one type of storage medium of a flash memory type, hard disk type, multimedia card micro type, and card type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data in a predetermined system. Since the types of memory 120 described above are only examples, the type of memory 120 may be configured in various manners within a range understandable to those skilled in the art based on the content of the present disclosure.

The memory 120 may structure, organize, and manage data required for the processor 110 to perform computation, the combination of data, and program codes executable on the processor 110. For example, the memory 120 may store program codes that enable the processor 110 to process data, program codes that enable the processor 110 to process commands in accordance with user input through the user interface, and various types of data that are generated according to the execution of program codes.

The network unit 130 according to an embodiment of the present disclosure may be understood as a configuration unit that transmits and receives data through any type of known wired/wireless communication system. For example, the network unit 130 may perform data transmission and reception using a wired/wireless communication system such as a local area network (LAN), a wideband code division multiple access (WCDMA) network, a long term evolution (LTE) network, the wireless broadband Internet (WiBro), a 5th generation mobile communication (5G) network, a ultra wide-band wireless communication network, a ZigBee network, a radio frequency (RF) communication network, a wireless LAN, a wireless fidelity network, a near field communication (NFC) network, or a Bluetooth network. Since the above-described communication systems are only examples, the wired/wireless communication system for the data transmission and reception of the network unit 130 may be applied in various manners other than the above-described examples.

The network unit 130 may receive data required for the processor 110 to perform computation through wired/wireless communication with any system client or the like. Furthermore, the network unit 130 may transmit data generated through the computation of the processor 110 through wired/wireless communication with any system or client or the like. The network unit 130 may transmit and receive the data, interaction with any entity, through generated through communication with the entity. For example, when user input for survey information and/or the like is received by a user terminal through the user interface, the network unit 130 may obtain the user input through communication with the user terminal. Furthermore, the network unit 130 may transmit the data, processed by the processor 110, to the user terminal.

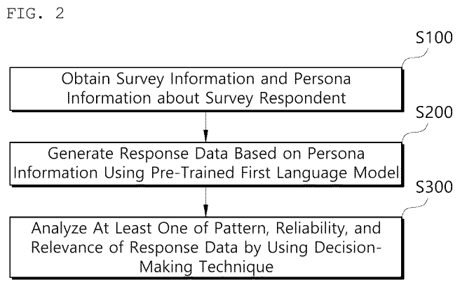

FIG. 2 is a flowchart illustrating a method of conducting surveys based on generative artificial intelligence according to an embodiment of the present disclosure.

Referring to FIG. 2, the computing apparatus 100 obtains survey information and persona information about a survey respondent in step S100.

The computing apparatus 100 generates response data based on the survey information and the persona information about the survey respondent using a pre-trained first language model in step S200. The response data generated through the first language model may be used to adjust the language distribution of the first language model or re-train the first language model based on user feedback.

The agent may collect survey information such as a survey topic, purpose, and target based on the input of a surveyor, and may utilize the survey information to determine context when generating response data. Since this agent is generated based on the pre-trained first language model, the persona information may be used as a prompt or initial value for the first language model. Furthermore, when a plurality of pieces of persona information are reflected in one piece of survey information, the agent may generate different pieces of response plurality of respective pieces of persona information. In this case, the response data generated by the agent includes response information and statistical information generated for the plurality of respective pieces of persona information, so that different questions and answers can be made based on the individual pieces of persona information in response to various scenarios or situations set for respective types by the surveyor.

In this case, since the agent is pre-trained with extensive knowledge in accordance with the time when the survey is conducted, it may generate response data for the survey information by reflecting the knowledge at the time when the survey is conducted therein in real time. To this end, the computing apparatus 100 may perform the process of training the first language model on a new training dataset using a pre-trained second language model. Accordingly, since the first language model is trained using a training dataset including a large amount of text data, it may have information about various contexts and topics. Through this training process, the agent based on the first language model may generate appropriate response data for various questions. Furthermore, the first language model has the ability to analyze and understand the question context of preset survey information, so that the agent can generate response data that matches the intent or purpose of a question.

In this manner, the agent may be generated based on the first language model that operates in conjunction with the second language model configured to dynamically generate a persona. The agent generated through this pre-trained first language model may generate response data by obtaining the ability to understand and generate language.

Meanwhile, persona information about a survey respondent targeted by the agent may be set by a survey terminal that conducts the survey. The persona information set in this manner may be used by the agent to generate response data by considering various characteristics such as gender, age, occupation, residential area, nationality, hobby, and family.

For example, when the nationality or residential area of the persona information has been set to a specific overseas country or place name, and age, occupation, and the like have been set in the persona information, knowledge information at the time when the survey is conducted is collected according to the country or place name, age, occupation, and the like, and the first language model is re-trained based on the knowledge information collected in this manner. Accordingly, according to the set persona information (for example, gender, age, occupation, nationality, and/or the like), there may be provided a response style that matches the persona information. Through this process, the agent may generate response data that desirably reflects the reactions or tendencies of a specific target group therein. Furthermore, the agent generates response data based on given conditions and information, i.e., the knowledge information at the time when the survey is conducted, the survey information, and the set persona information, so that it can provide consistent response data without human subjectivity or bias. Furthermore, the first and second language models, which are the basis of the agent, are continuously re-trained using a new learning dataset, thereby generating response data that reflects the latest knowledge information and trend therein.

The computing apparatus 100 may adjust or improve the response data of the agent in real time according to the reaction of the user or surveyor by applying feedback technology for the generated response data.

The computing apparatus 100 may analyze at least one of the pattern, reliability and relevance of the response data using a decision-making technique in step S300. In this case, any one of KANO, TOPSIS, AHP, conjoint analysis, Quality Function Deployment (QFD), and A/B testing may be used as the decision-making technique.

The computing apparatus 100 may provide reliable information, such as response characteristics and distribution for each piece of persona information, as a result of analysis of the response data. Accordingly, the computing apparatus 100 may store the response data and feedback information generated by the agent in a database and use them for future analysis and verification. The computing apparatus 100 derives meaningful insights by applying various analysis techniques based on the response data stored in the database. Through this analysis process, the value of the response data generated by the agent may be maximized, and the information that can be utilized for decision making may be derived.

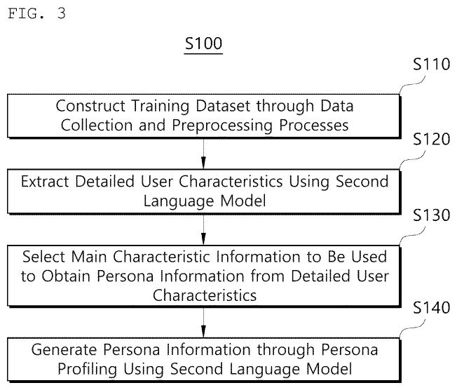

FIG. 3 is a flowchart showing in detail the step of acquiring persona information according to an embodiment of the present invention.

Step S100 of acquiring persona information according to an embodiment of the present invention may include steps such as characteristic extraction, dynamic persona profiling, etc. required for generating persona information in detail.

The computing apparatus 100 constructs a training dataset through the data collection and preprocessing of text data, such as knowledge information at the time when the survey is conducted and question and response data, based on basic user information and the second language model in step S110. In this case, the data collection and pre-processing processes perform text data purification, tokenization, and vectorization.

The computing apparatus 100 extracts detailed characteristic information about the survey respondent based on basic information about the survey respondent and question information related to the basic information by using a pre-trained second language model in step S120.

For example, when the computing apparatus 100 inputs question information related to basic user information such as “What hobby is the user likely to have?” to the second language model, which is a large language model (LLM), it may be provided with response data in a text form for the question by the second language model, and may utilize this response data as the lifestyle information of detailed characteristic information about the persona information.

The computing apparatus 100 selects main characteristic information to be used to obtain persona information from the detailed characteristic information generated by the second language model based on the user input in step S130. For example, the main characteristic information may include information such as a hobby, a view of value, a communication style, and the like.

The computing apparatus 100 may dynamically generate persona information through persona profiling based on the main characteristic information and additional question information related to the main characteristic information by using the second language model in step S140. For example, a question such as “What will be the characteristics of the communication style of the user?” is input to the second language model as the additional question information related to the main characteristic information, and the persona information may be configured in more detail based on the prediction results of the second language model, i.e., the response data.

Furthermore, when plurality of pieces of main characteristic information are selected, the computing apparatus 100 may generate persona information by combining the plurality of pieces of main characteristic information. For example, the new persona information “a college student who likes books and is active” may be generated by combining two pieces of main characteristic information, i.e., “an active college student” and “an introvert who likes books.”

Meanwhile, the computing apparatus 100 may dynamically re-train the second language model based on user feedback on the generated persona information or the performance metrics of the second language model, thereby increasing the performance of the second language model, i.e., the accuracy of persona generation.

Furthermore, the computing apparatus 100 may generate automatic feedback information based on the performance (e.g., the response accuracy) of the agent and provide the feedback information, provided by the agent, to a training dataset, thereby improving the performance, i.e., the accuracy of persona generation, of the second language model by re-training the second language model using a newly constructed training dataset.

In this manner, the computing apparatus 100 may continuously monitor the performance of the second language model required for persona generation by utilizing the performance evaluation metrics of the agent, and, if necessary, improve the accuracy of persona generation through the process of re-training the second language model. Furthermore, due to this, the performance of the first language model may be improved based on the second language model.

Meanwhile, the persona information may include various types of information. For example, the persona information may include information ranging from basic characteristic information such as age, gender, occupation, hobby, personality, and consumption pattern to deep-level information such as the preference for technology, decision-making process, and view of value of a user. Accordingly, the computing apparatus 100 may generate persona information based on a classification system stratified according to the characteristics of the survey respondent. This classification system may include first to fifth classification systems.

The first classification system concerns basic characteristics including demographic information, occupational and professional information, and education level information. The first classification system may include demographic information such as age, gender, nationality and residential area, occupational and professional information such as occupational group, specialty field, career period and work environment, and education level information such as the highest level of education, major, additional education and certification.

The second classification system concerns lifestyle including hobby and interest information, consumption habit information, and health and physical information. The second classification system may include hobby and interest information such as art, sports, travel, music and books, consumption habit information such as consumption preferences, major purchase items, purchase frequency and purchase channel selection (online vs. offline), and health and physical information such as physical characteristics, health status, eating habits, and exercise habits. In particular, the hobby and interest information may be subdivided into a plurality of categories.

The third classification system concerns view-of-value and psychological characteristics including view-of-value information, personality information, decision-making style information, and communication style information. The third classification system may include view-of-value information about value awareness for the environment, society, politics, economy and ethics, personality information about personality type such as MBTI or Big Five, decision-making style information such as intuitive vs. analytical or open vs. conservative, and communication style information such as passive, active, aggressive and friendly.

The fourth classification system concerns technology and media usage habits including technology consumption preference information and media consumption pattern information. The fourth classification system may include technology consumption preference information such as smartphone usage frequency, computer and Internet utilization level and SNS platform preferences, and media consumption pattern information such as major viewing media channels, preferred content genres and media consumption time.

The fifth classification system concerns social networks and relationships including social relationships and social networking habits. The fifth classification system may include social relationship information such as the depth and frequency of relationships with family, friends and colleagues, and social networking habit information such as the frequency of online and offline network activity and major network platforms.

Meanwhile, the computing apparatus 100 may collect user feedback information about the generated persona information and provide the persona information and user feedback information to the training dataset, thereby improving the performance, i.e., the accuracy of persona generation, of the second language model by re-training the second language model using the newly constructed training dataset.

Furthermore, the computing apparatus 100 may automatically generate feedback information based on the performance (e.g., the response accuracy) of the agent and provide the feedback information, provided by the agent, to the training dataset, thereby improving the performance, i.e., the accuracy of persona generation, of the second language model by re-training the second language model using the newly constructed learning dataset.

In this manner, the computing apparatus 100 may continuously monitor the performance of the second language model required for persona generation by utilizing the performance evaluation metrics of the agent, and, if necessary, improve the accuracy of persona generation through the process of re-training the second language model. Furthermore, due to this, the performance of the first language model may also be improved based on the second language model.

In this manner, in the present disclosure, the agent intelligence-based model may generate using artificial personalized response data by reflecting the persona information of a survey respondent therein, so that response data that desirably matches the interests and characteristics of the survey respondent can be provided, thereby increase the effectiveness and reliability of the response data.

Furthermore, in the present disclosure, the latest knowledge information at the time when a survey is conducted is collected in the form of text data through crawling, a training dataset is constructed by preprocessing the collected text data, and the process of re-training the second language model is performed using the constructed training dataset. Accordingly, the agent generated using the first language model operating in conjunction with the second language model may generate response data by reflecting knowledge information at the time when the survey is conducted therein in real time. As a result, the freshness and accuracy of the response data may be ensured.

In the present disclosure, the response data generated by the agent may be stored in the database, and the response data stored in the database may be efficiently analyzed using various analysis techniques. Accordingly, in the present disclosure, insights related to persona information about survey respondents may be derived more precisely, and information useful for decision-making may be provided.

Above all, compared to a telephone survey or the survey work that involves asking questions to a survey respondent and waiting for responses to the questions, the present disclosure enables the agent to automatically generate response data by combining survey information and persona information. Accordingly, faster and more consistent survey results may be generated, corresponding amounts of time and money may be reduced, changes in the opinions or trends of survey respondents may be rapidly determined, and the rapid analysis of the survey results and rapid responses thereto are enabled.

Therefore, the method of conducting surveys based on generative artificial intelligence according to an embodiment of the present disclosure may be applied to various fields such as the market research and marketing field, the medical field, the education field, the entertainment field, and the corporate or information policy decision-making field.

The present disclosure provides the method and apparatus that may generate response data like humans based on survey information and respondent persona information about survey respondents by using the pre-trained artificial intelligence-based model and may derive meaningful information by analyzing the patterns, reliability, and relevance of the response data through various analysis techniques. Therefore, faster and more consistent survey results may be generated, required time and money may be significantly reduced compared to the conventional survey methods, changes in the opinions or trends of survey respondents may be rapidly determined, the rapid analysis of the survey results and rapid responses thereto are enabled, and conversation-type interaction methods may be popularized by using agents in various fields.

The various embodiments of the present disclosure described above may be combined with one or more additional embodiments, and may within be changed the range understandable to those skilled in the art in light of the above detailed description. The embodiments of the present disclosure should be understood as illustrative but not restrictive in all respects. For example, individual components described as unitary may be implemented in a distributed manner, and similarly, the components described as distributed may also be implemented in a combined form. Accordingly, all changes or modifications derived from the meanings and scopes of the claims of the present disclosure and their equivalents should be construed as being included in the scope of the present disclosure.

What is claimed is:

1. A method of conducting surveys based on generative artificial intelligence, the method being performed by a computing apparatus including at least one processor, the method comprising:
obtaining survey information and persona information about a survey respondent; and
generating response data based on the survey information and the persona information about the survey respondent by using a pre-trained first language model.

2. The method of claim 1, wherein obtaining the survey information and the persona information about the survey respondents comprises:
extracting detailed characteristic information about the survey respondent based on basic information about the survey respondent and question information related to the basic information by using a pre-trained second language model;
selecting main characteristic information to be used to obtain the persona information from detailed characteristic information, generated by the second language model, based on user input; and
generating the persona information based on the main characteristic information and additional question information related to the main characteristic information by using the second language model.

3. The method of claim 2, wherein, when a plurality of pieces of main characteristic information are selected as the main characteristic information, the persona information is generated by combining the plurality of pieces of main characteristic information.

4. The method of claim 2, wherein the second language model is dynamically re-trained based on user feedback on the generated persona information or performance metrics of the second language model.

5. The method of claim 1, wherein the persona information is based on a classification system stratified according to characteristics of the survey respondent.

6. The method of claim 5, wherein the classification system comprises:
a first classification system for basic characteristics including demographic and information, occupational professional information, and education level information;
a second classification system for lifestyle including hobby and interest information, consumption habit information, and health and physical information;
a third classification system for view-of-value and psychological characteristics including a view of value, personality, decision-making style, and communication style;
a fourth classification system for technology and media usage habits including technology consumption preferences and media consumption patterns; and
a fifth classification system for social networks and relationships including social relationships and social networking habits.

7. The method of claim 1, wherein the response data generated through the first language model is used to adjust language distribution of the first language model or re-train the first language model based on user feedback.

8. The method of claim 1, wherein, when the persona information includes a plurality of pieces of persona information, the response data generated through the first language model includes response information and statistical information generated for each of the plurality of pieces of persona information.

9. The method of claim 1, further comprising analyzing at least one of a pattern, reliability, and relevance of the response data by using a decision-making technique.

10. A computing apparatus for implementing a method of conducting surveys on based generative artificial intelligence, the computing apparatus comprising:
a processor including at least one core; and
memory including program codes executable on the processor;
wherein the processor, according to execution of the program codes, obtains survey information and persona information about a survey respondent and generates response data based on the survey information and the persona information about the survey respondent by using a pre-trained first language model.
